(19) United States
(12) Patent Application Publication
(10) Pub. No.: US 2021/0155554 A1
(43) Pub. Date: May 27, 2021

(54) Granules

(71) Applicant: 3M INNOVATIVE PROPERTIES COMPANY, St. Paul, MN (US)

(72) Inventors: Taisiya Skorina, Woodbury, MN (US); Rebecca L. A. Everman, Falcon Heights, MN (US); Jean A. Tangeman, Minneapolis, MN (US); Robert P. Brown, Hudson, WI (US); Kenton D. Budd, Woodbury, MN (US)

(21) Appl. No.: 17/047,525

(22) PCT Filed: Mar. 19, 2019
(86) PCT No.: PCT/IB2019/052224

§ 371 Date: Oct. 14, 2020

Related U.S. Application Data
(60) Provisional application No. 62/661,229, filed on Apr. 23, 2018.

(51) Int. Cl. C04B 38/00; E04D 7/00; C04B 41/45; C04B 41/52; C04B 41/50

(52) U.S. Cl. CPC C04B 38/009; E04D 7/005; C04B 38/0051; C04B 2235/5436; C04B 41/52; C04B 41/4584; C04B 41/5024; C04B 41/4505

(57) ABSTRACT

Plurality of granules comprising a ceramic core having an outer surface and a shell on and surrounding the core, wherein the core comprises first ceramic particles bound together with a first inorganic binder, wherein the first inorganic binder comprises reaction product of at least alkali silicate and hardener, wherein the shell comprises at least a first concentric layer, wherein the first layer comprises a second inorganic binder and optionally second ceramic particles, wherein if present the second ceramic particles are bound together with the second inorganic binder, wherein the second inorganic binder comprises reaction product of at least alkali silicate and hardener, wherein for a given granule, the first ceramic particles are present in a first weight percent with respect to the total weight of the core and the second ceramic particles, if present in the first layer of the same granule are in a second weight percent with respect to the total weight of the first layer, wherein for a given granule, the first weight percent is greater than the second weight percent, and wherein the granules have a minimum Total Solar Reflectance of at least 0.7. The granules are useful, for example, as roofing granules.

### CROSS REFERENCE TO RELATED APPLICATION

This application claims the benefit of U.S. Provisional Patent Application No. 62/661,229, filed Apr. 23, 2018, the disclosure of which is incorporated by reference herein in its entirety.

### BACKGROUND

Conventional roofing granules consist of a core baserock of dacite, nepheline syenite, rhyolite, andesite, etc., coated with at least one layer of pigment-containing coating. A typical coating is composed of sodium silicate mixed with raw clay and a pigmenting oxide. Energy efficient shingles are designed to have improved solar reflectivity. Titania pigmented standard white granules are known, but total reflectance of these pigments is limited by absorbance of the baserock (as conventional pigment layers do not completely “hide” the underlying base), and by absorbance in the binder system by components such as the clay.

### SUMMARY

In one aspect, the present disclosure describes a plurality of granules comprising a ceramic core having an outer surface and a shell on and surrounding the core, wherein the core comprises first ceramic particles bound together with a first inorganic binder, wherein the first inorganic binder comprises reaction product of at least alkali silicate and hardener (in some embodiments further comprising alkali silicate itself), wherein the shell comprises at least a first concentric layer, wherein the first layer comprises a second inorganic binder and optionally second ceramic particles, wherein if present the second ceramic particles are bound together with the second inorganic binder, wherein the second inorganic binder comprises reaction product of at least alkali silicate and hardener (in some embodiments further comprising alkali silicate itself), wherein for a given granule, the first ceramic particles are present in a first weight percent with respect to the total weight of the core and the second ceramic particles, if present in the first layer of the same granule are in a second weight percent with respect to the total weight of the first layer, wherein for a given granule, the first weight percent is greater than the second weight percent, and wherein the granules have a minimum Total Solar Reflectance (TSR) (as determined by the Total Solar Reflectance Test described in the Examples) of at least 0.7 (in some embodiments, of at least 0.75, or even at least 0.8).

In this application:

“amorphous” refers to material that lacks any long-range crystal structure, as determined by the X-ray diffraction technique described in the Examples;

“ceramic” refers to a metal (including silicon) oxide, which may include at least one of a carbon or a nitrogen, in at least one of an amorphous, crystalline, or glass-ceramic form;

“functional additive” refers to a material that substantially changes at least one property (e.g., durability and resistance to weathering) of a granule when present in an amount not greater than 10 percent by weight of the granule;

“glass” refers to amorphous material exhibiting a glass transition temperature;

“hardener” refers to a material that initiates and/or enhances hardening of an aqueous silicate solution; hardening implies polycondensation of dissolved silica into three-dimensional Si—O—Si(Al, bond network and/or crystallization of new phases; in some embodiments, the granules comprise excess hardener;

“mineral” refers to a solid inorganic material of natural occurrence; and

“partially crystallized” refers to material containing a fraction of material characterized by long range order.

In another aspect, the present disclosure describes a method of making the plurality of granules described herein, the method comprising:

providing a plurality of ceramic cores comprising the first ceramic particles bound together with the first inorganic binder;

coating each of the ceramic cores with a first layer precursor, wherein the first layer precursor comprises a first aqueous dispersion comprising the second alkali silicate precursor, and the second hardener precursor (optionally further comprising the second ceramic particles); and

curing the coated aqueous dispersion to provide the plurality of granules.

Granules described herein are useful, for example, as roofing granules.

Advantages of some embodiments of granules described herein may include high TSR (i.e., at least 70%) with low to moderate cost (i.e., $200 to $2000 per ton), low dust (i.e., comparable to conventional roofing granules), low staining (i.e., stain test values less than 10), and good mechanical properties (i.e., tumble toughness values of at least 50).

### DETAILED DESCRIPTION

In some embodiments of pluralities of granules described herein, for a given granule, a concentric layer can be contiguous or noncontiguous.

In some embodiments the core has a diameter of at least 200 micrometers (in some embodiments, at least 250 micrometers, 300 micrometers, 400 micrometers, 500, micrometers, 750 micrometers, 1 mm, 1.5 mm, or even 2 mm; in some embodiments, in a range from 200 micrometers to 2 mm, 300 micrometers to 1.5 mm, 400 micrometers to 1 mm, 500 micrometers to 1 mm, 300 micrometers to 1 mm, 300 micrometers to 2 mm, or even 1 mm to 2 mm).

In some embodiments of pluralities of granules described herein, a given granule further comprises at least one additional layer (e.g., a second, third, a fourth, or more layer(s)). In some embodiments, the additional layer(s) comprises inorganic binder and optionally ceramic particles; in some embodiments, if present the ceramic particles are bound together with the inorganic binder; in some embodiments, the inorganic binder comprises reaction product of at least alkali silicate and hardener.

In some embodiments of pluralities of granules described herein, for a given granule, further comprise a second layer disposed between the core and the first layer (in some embodiments, the second layer comprises a third inorganic binder and optionally third ceramic particles; in some embodiments, if present the third ceramic particles are bound together with the third inorganic binder; in some embodiments, the third inorganic binder comprises reaction product of at least alkali silicate and hardener (in some embodiments further comprising alkali silicate itself)). In some embodiments, for a given granule, further comprising a third layer disposed between the first and second layers (in some embodiments, the third layer comprises a fourth inorganic binder and optionally fourth ceramic particles; in some embodiments, if present the fourth ceramic particles are bound together with the fourth inorganic binder; in some embodiments, the fourth inorganic binder comprises reaction product of at least alkali silicate and hardener (in some embodiments further comprising alkali silicate itself)).

In some embodiments, for a given granule, further comprise a fourth layer disposed between the core and the first layer (in some embodiments, the fourth layer comprises a fifth inorganic binder and optionally fifth ceramic particles; in some embodiments, if present the fifth ceramic particles are bound together with the fifth inorganic binder; in some embodiments, the fifth inorganic binder comprises reaction product of at least alkali silicate and hardener (in some embodiments further comprising alkali silicate itself)).

Typically, the shell has an average thickness of at least 0.1 (in some embodiments, at least 0.5, 1, 2, 5, 10, 25, 50, 75, or even at least 100; in some embodiments, in a range from 0.1 to 100, 0.5 to 100, 0.5 to 50, 1 to 100, 1 to 50, 5 to 75, 5 to 50, or even 10 to 30) micrometer.

In some embodiments of pluralities of granules described herein, the shell of each granule collectively comprises at least 80 (in some embodiments, at least 85, 90, or even at least 95; in some embodiments, in a range from 80 to 95) percent by weight collectively of the ceramic particles, alkali silicate, and reaction product of the alkali silicate and the hardener, based on the total weight of the shell of the respective granule.

In some embodiments of pluralities of granules described herein, for a given granule, the core has an average radius and the first layer has a first average thickness, and wherein for the same granule, the average radius of the core is greater than the first average thickness. In some embodiments, the first average thickness is at least 0.1 (in some embodiments, at least 0.5, 1, 2, 5, 10, 25, 50, 75, or even at least 100; in some embodiments, in a range from 0.1 to 100, 0.5 to 100, 0.5 to 50, 1 to 100, 1 to 50, 5 to 75, 5 to 50, or even 10 to 30) micrometer. In some embodiments, the average radius is at least 50 (in some embodiments, at least 75, 100, 250, 500, or even at least 1000; in some embodiments, in a range from 50 to 1000, 100 to 500, or even 150 to 250) micrometers. Average thickness and average radius are determined from an image (for example, an image from SEM, an optical microscope, or an SEM compositional map obtained using XRF) of a cross section of a granule.

Suitable alkali silicates include cesium silicate, lithium silicate, a potassium silicate, or a sodium silicate. Exemplary alkali silicates are commercially available, for example, from PQ Corporation, Malvern, Pa. In some embodiments, the inorganic binder further comprises reaction product of amorphous aluminosilicate hardener.

In some embodiments of pluralities of granules described herein, the hardener is at least one an aluminum phosphate, an aluminosilicate, a cryolite, a calcium salt (e.g., CaCl₂)), or a calcium silicate. In some embodiments, the hardener may further comprise zinc borate. In some embodiments, the hardener is amorphous. Exemplary hardeners are commercially available, for example, from commercial sources such as Budenheim Inc., Budenheim, Germany, and Solvay Fluorides, LLC, Houston, Tex.

In some embodiments of pluralities of granules described herein, the first and second inorganic binders are the same. Same inorganic binder means the same alkali silicate(s) and same hardeners are present in the same ratios. Same alkali means the same alkali element(s). Same hardener means the average amount of each element that is present in an amount greater than 10 wt. % based on the total weight of the hardener, the average amount of each phase that is present in an amount greater than 10 volume percent, the density, the mean particle size, and the mean crystallite size, are each within 10% of the average value of each other for respective hardeners. For example, if a first hardener consists of an average of 40 wt. % Si, then a second hardener must have an average silica content in a range from 36 wt. % to 44 wt. % to be considered the same. Further, the ratio of total moles of alkali ions to silicon ions, the ratio of each alkali to each additional alkali (if present), and the ratio of hardener solids to alkali silicate solids are all within 10% of each other for respective inorganic binders (i.e., a Si to alkali mole ratio of between 1.8 and 2.2 is within 10% of a ratio of 2.0). In some embodiments of pluralities of granules described herein, the first and second inorganic binders are different (i.e., not the same).

In some embodiments of pluralities of granules described herein, the inorganic binder is present as at least 5 (in some embodiments, at least 10, 15, 20, 25, 30, 35, 40, or 45, or even up to 50; in some embodiments, in a range from 5 to 50, 10 to 50, or even 25 to 50) percent by weight of the shell of each granule, based on the total weight of the shell of the respective granule.

In some embodiments of pluralities of granules described herein, the ceramic particles comprise at least one component with Total Solar Reflectance (as determined by the Total Solar Reflectance Test described in the Examples) of at least 0.7. Such exemplary ceramic particles include aluminum hydroxide, metal or metalloid oxide (e.g., silica (e.g., crystoballite, quartz, etc.), an aluminate (e.g., alumina, mullite, etc.), a titanate (e.g., titania), and zirconia), a silicate glass (e.g., soda-lime-silica glass, a borosilicate glass), porcelain, calcite, or marble. In some embodiments, the ceramic particles comprise mineral. Exemplary sources of ceramic particles include Vanderbilt Minerals, LLC, Norwalk, Conn.; Dadco, Lausanne, Switzerland; American Talc Company, Allamoore, Tex.; Imerys, Inc., Cockeysville, Md.; and Cristal Metals, Woodridge, Ill.

In some embodiments of pluralities of granules described herein where the second ceramic particles are present, the first and second ceramic particles are the same. “Same ceramic particles” means the average amount of each element that is present in an amount greater than 10 wt. % based on the total weight of the ceramic particles, the average amount of each phase that is present in an amount greater than 10 volume percent, the density, the mean particle size, and the mean crystallite size, are each within 10% of the average value of each other for respective ceramic particles. For example, if first ceramic particles consist of an average of 40 wt. % Si, then second ceramic particles must have an average silica content in a range from 36 wt. % to 44 wt. % to be considered the same. In some embodiments of pluralities of granules described herein where the second ceramic particles are present, the first and second ceramic particles are different.

In some embodiments, the ceramic particles of each granule comprise no greater than 10 (in some embodiments, no greater than 5, 4, 3, 2, 1, or even zero) percent by weight pure TiO₂, based on the total weight of the granule. In some embodiments, the ceramic particles of each granule comprise no greater than 10 (in some embodiments, no greater than 5, 4, 3, 2, 1, or even zero) percent by weight pure Al₂O₃, based on the total weight of the granule.

In some embodiments of pluralities of granules described herein, the ceramic particles have an average size in a range from 200 nanometers to 200 micrometers (in some embodiments, in a range from 200 nanometers to 100 micrometers, 250 nanometers to 50 micrometers, 500 nanometers to 20 micrometers, 1 micrometer to 10 micrometers, or even 2 micrometers to 20 micrometers). In some embodiments, the ceramic particles have a continuous or bimodal distribution of sizes. In some embodiments, the ceramic particles may have a broad distribution of particle sizes, while in others, it may have a narrow distribution of particle sizes.

In some embodiments of pluralities of granules described herein, at least one of the first or second ceramic particles independently each have a longest dimension, wherein the granules each have a longest dimension, and wherein the longest dimension of each ceramic particle for a given granule is no greater than 10% (in some embodiments, no greater than 20%) of the longest dimension of said given granule.

In some embodiments of pluralities of granules described herein, the granules further comprise at least one of a functional additive (e.g., rheology modifier, durability modifier, and fluxing agent), organic binder, or pigment. Exemplary rheology modifiers include surfactants. Exemplary durability modifiers include nanosilica, pyrogenic (“fumed”) silica, and silica fume, which are available, for example, from Evonik Industries, Essen, Germany.

Exemplary fluxing agents include borax, which is available, for example, from Rio Tinto Minerals, Boron, Calif. Exemplary organic binders include dextrin and carboxymethylcellulose, which are available, for example, from Dow Chemical Company, Midland, Mich.

In some embodiments of pluralities of granules described herein, for a given granule, the first weight percent of the first ceramic particles is in a range from 30 to 90, (in some embodiments, in a range from 40 to 80, 50 to 80, or even 60 to 80) weight percent with respect to the core, and wherein for the same granule, the second weight percent of the second ceramic particles is in a range from 0 to 50, (in some embodiments, in a range from 10 to 40, 10 to 30, or even 5 to 25; in some embodiments, zero) weight percent with respect to the first layer.

In some embodiments of pluralities of granules described herein, for a given granule, the core has a first volume percent porosity and the first layer of the same granule has a second volume percent porosity, wherein the first volume percent porosity of the core based on the total volume of the core is greater than the second volume percent porosity of the respective first layer, based on the total volume of the first layer. In some embodiments, for a given granule, the first volume percent porosity is in a range from 20 to 70, (in some embodiments, in a range from 20 to 60, 25 to 50, or even 30 to 45) volume percent with respect to the core, and wherein for the same granule, the second volume percent porosity is in a range from 0 to 40, (in some embodiments, in a range from 0 to 30, 0 to 20, or even 0 to 10; in some embodiments, zero) volume percent with respect to the total volume of the first layer. Porosity as described above is typically associated with voids (that are not, for example, not filled with binder) between and among ceramic particles. Such voids are typically useful for scattering and reflecting solar radiation. The volume percent porosity as described above is measured using mercury porosimetry, as described in the Examples. Although not wanting to be bound by theory, very fine nanoscale porosity (e.g., with pore diameters less than about 50 nanometers), if present, typically originates within the binder phase, is much less effective for scattering solar radiation, and is not included in the volume percent porosity amounts recited above.

A plurality of granules described herein can be made, for example by a method comprising:

providing a plurality of ceramic cores comprising the first ceramic particles bound together with the first inorganic binder;

coating each of the ceramic cores with a first layer precursor, wherein the first layer precursor comprises a first aqueous dispersion comprising the second alkali silicate precursor, and the second hardener precursor (optionally further comprising the second ceramic particles); and

curing the coated aqueous dispersion to provide the plurality of granules.

Cores can be made by providing an aqueous dispersion comprising ceramic particles, alkali silicate, and hardener, and drying the dispersion using a process capable of forming dried agglomerates of the material, and curing the agglomerates. The process can comprise feeding the dispersion into an agglomerator. Other suitable processes include, for example, pan drying the dispersion, and crushing the dried material to form dried agglomerates.

Additional layers may be added using processes used for the first layer.

In some embodiments, curing is conducted at least in part at a temperature in a range from 40° C. to 500° C., 50° C. to 450° C., 50° C. to 350° C., 50° C. to 250° C., 50° C. to 200° C., 50° C. to 150° C., 50° C. to 100° C., or even 50° C. to 80° C. In some embodiments, curing is conducted in two stages. For example, a first curing stage at least in part at a temperature in a range from 20° C. to 100° C., and a second, final curing stage at least in part at a temperature in a range from 200° C. to 500° C. In some embodiments, the heating rate for each stage is at one or more rates in a range from 5° C./min. to 50° C./min. In some embodiments, the feeding is over a period of time in a range from 5 minutes to 500 minutes. In some embodiments, the heating is at a temperature in a range from 50° C. to 200° C.

In some embodiments, wherein water is present in the first aqueous dispersions (and independently for any other aqueous dispersions (e.g., for making the core and/or additional layers) up to 75 (in some embodiments, up to 70, 65, 60, 55, 50, 45, 40, 35, 30, 25, 20, or even up to 15; in some embodiments, in a range from 15 to 75, 15 to 50, or even 15 to 35) percent by weight, based on the total weight of the respective aqueous dispersion.

In some embodiments, coating the ceramic core with the shell comprises fluidized bed coating. In some embodiments, the fluidized bed coating comprises fluidizing ceramic cores, heating the bed of fluidized cores, and continuously feeding the aqueous dispersion into the fluidized bed.

In some embodiments of pluralities of granules described herein, the granules have sizes in a range from 200 micrometers to 5 millimeters (in some embodiments, in a range from 200 micrometers to 2 millimeters, 300 micrometers to 1 millimeter, 400 micrometers to 1 millimeter; 500 micrometers to 2 millimeters; or even 1 millimeter to 5 millimeters).

In some embodiments, the inorganic binder is amorphous. In some embodiments, the inorganic binder is partially crystallized.

In some embodiments of pluralities of granules described herein, the granules have a density in a range from 0.5 g/cm³ to 3 g/cm³.

Shaped granules can be formed, for example, by using shaped cores. Granules described herein may be in any of a variety of shapes, including cubes, truncated cubes, pyramids, truncated pyramids, triangles, tetrahedra, spheres, hemispheres, and cones. In some embodiments, a granule can have a first face and a second face separated by a thickness. In some embodiments, such granules further comprise at least one of a straight or sloping wall.

In some embodiments of pluralities of granules described herein, the granules have a Tumble Toughness Value of least 70 (in some embodiments, at least 75, 80, 85, 90, 95, 96, 97, 98, or even at least 99) before immersion in water and at least 50 (in some embodiments, at least 55, 60, 65, 70, 75, 80, 85 or even at least 90) after immersion in water at 20° C.±2° C. for two months.

In some embodiments of pluralities of granules described herein, the granules have a Stain Value (as determined by the Stain Value Test described in the Examples) of not greater than 15 (in some embodiments, not greater than 10, 5, 4, 3, 2, 1, or even not greater than 0.5).

In some embodiments, the granules further comprise at least one adhesion promoter (e.g., a polysiloxane). The polysiloxane can contain a hydrocarbon tail for better wetting with the hydrophobic asphalt. A siloxane bond can form, for example, between a granule surface and the polysiloxane, via condensation reaction, leaving the hydrophobic hydrocarbon tail on the granule surface. Although not wanting to be bound by theory, the transformation of the hydrophilic surface into a hydrophobic oily surface improves wetting of the granule surface by the asphalt. Exemplary polysiloxanes include “SILRES BS 60” or “SILRES BS 68” from Wacker Chemical Corporation, Adrian, Mich.

In some embodiments of pluralities of granules described herein, the granules further comprise at least one dust suppressant (e.g., an acrylic polymer comprising a quaternary ammonium moiety and a nonionic monomer). Although not wanting to be bound by theory, dust suppressant is believed to suppress dust through ionic interaction of the positively charged quaternary ammonium moiety and negatively charged dust particles. The quaternary ammonium moiety may also form, for example, an ionic bond with natural mineral. Furthermore, it may ionically bond with ionic species in asphalt, particularly polyphosphoric acid (PPA) added asphalt. Of course, other anionic species are present in asphalt, including non-PPA asphalt, to which an ionic bond may form. Accordingly, a dust suppression coating composition comprising a quaternary ammonium compound as described herein may also serve as an adhesion promoter.

In some embodiments of pluralities of granules described herein, the dust suppression coating polymer comprises water-based polymers, such as a polyacrylate (e.g., an acrylic emulsion polymer). In some embodiments, the coating polymer is a polymer such as described in PCT Pat. Pub. Docs. WO2015157615 A1, and WO2015157612 A1, published Oct. 15, 2015, the disclosures of which are incorporated herein by reference.

Granules described herein are useful, for example, as roofing granules. For example, granules described herein can be used to make roofing material (e.g., a shingle) comprising a substrate and the granules thereon. In some embodiments, the roofing material has a Total Solar Reflectance (TSR) (as determined by the Total Solar Reflectance Test described in the Examples) of at least 60 (in some embodiments, at least 63, 65, or even at least 70) percent

Advantages of embodiments of granules described herein may include high TSR (i.e., at least 70%) with low to moderate cost (i.e., $200 to $2000 per ton), low dust (i.e., comparable to conventional roofing granules), low staining (i.e., stain test values of less than 10), and good mechanical properties (i.e., tumble toughness values of at least 50).

### Exemplary Embodiments

1A. A plurality of granules comprising a ceramic core having an outer surface and a shell on and surrounding the core, wherein the core comprises first ceramic particles bound together with a first inorganic binder, wherein the first inorganic binder comprises reaction product of at least alkali silicate and hardener (in some embodiments further comprising alkali silicate itself), wherein the shell comprises at least a first concentric layer, wherein the first layer comprises a second inorganic binder and optionally second ceramic particles, wherein if present the second ceramic particles are bound together with the second inorganic binder, wherein the second inorganic binder comprises reaction product of at least alkali silicate and hardener (in some embodiments further comprising alkali silicate itself), wherein for a given granule, the first ceramic particles are present in a first weight percent with respect to the total weight of the core and the second ceramic particles, if present in the first layer of the same granule are in a second weight percent with respect to the total weight of the first layer, wherein for a given granule, the first weight percent is greater than the second weight percent, and wherein the granules have a minimum Total Solar Reflectance (TSR) (as determined by the Total Solar Reflectance Test described in the Examples) of at least 0.7 (in some embodiments, of at least 0.75, or even at least 0.8).
2A. The plurality of granules of Exemplary Embodiment 1A, wherein for a given granule, the first weight percent of the first ceramic particles is in a range from 30 to 90, (in some embodiments, in a range from 40 to 80, 50 to 80, or even 60 to 80) weight percent with respect to the core, and wherein for the same granule, the second weight percent of the second ceramic particles is in a range from 0 to 50, (in some embodiments, in a range from 10 to 40, 10 to 30, or even 5 to 25; in some embodiments, zero) weight percent with respect to the first layer.
3A. The plurality of granules of any preceding A Exemplary Embodiment, wherein for a given granule, the core has a first volume percent porosity and the first layer of the same granule has a second volume percent porosity, wherein the first volume percent porosity of the core based on the total volume of the core is greater than the second volume percent porosity of the respective first layer, based on the total volume of the first layer.
4A. The plurality of granules of Exemplary Embodiment 3A, wherein for a given granule, the first volume percent porosity is in a range from 20 to 70, (in some embodiments, in a range from 20 to 60, 25 to 50, or even 30 to 45) volume percent with respect to the core, and wherein for the same granule, the second volume percent porosity is in a range from 0 to 40, (in some embodiments, in a range from 0 to 30, 0 to 20, or even 0 to 10; in some embodiments, zero) volume percent with respect to the first layer.
5A. The plurality of granules of any preceding A Exemplary Embodiment, wherein for a given granule, the first layer is contiguous or noncontiguous.
6A. The plurality of granules of any preceding A Exemplary Embodiment, wherein for a given granule, further comprising a second layer disposed between the core and the first layer (in some embodiments, the second layer comprises a third inorganic binder and optionally third ceramic particles; in some embodiments, if present the third ceramic particles are bound together with the third inorganic binder; in some embodiments, the third inorganic binder comprises reaction product of at least alkali silicate and hardener (in some embodiments further comprising alkali silicate itself)).
7A. The plurality of granules of Exemplary Embodiment 6A, wherein for a given granule, further comprising a third layer disposed between the first and second layers (in some embodiments, the third layer comprises a fourth inorganic binder and optionally fourth ceramic particles; in some embodiments, if present the fourth ceramic particles are bound together with the fourth inorganic binder; in some embodiments, the fourth inorganic binder comprises reaction product of at least alkali silicate and hardener (in some embodiments further comprising alkali silicate itself)).
8A. The plurality of granules of Exemplary Embodiment 7A, wherein for a given granule, further comprise a fourth layer disposed between the core and the first layer (in some embodiments, the fourth layer comprises a fifth inorganic binder and optionally fifth ceramic particles; in some embodiments, if present the fifth ceramic particles are bound together with the fifth inorganic binder; in some embodiments, the fifth inorganic binder comprises reaction product of at least alkali silicate and hardener (in some embodiments further comprising alkali silicate itself)).
9A. The plurality of granules of any preceding A Exemplary Embodiment, wherein for a given granule, the core has an average radius and the first layer has a first average thickness, and wherein for the same granule, the average radius of the core is greater than the first average thickness.
10A. The plurality of granules of Exemplary Embodiment 9A, wherein the first average thickness is at least 0.1 (in some embodiments, at least 0.5, 1, 2, 5, 10, 25, 50, 75, or even at least 100; in some embodiments, in a range from 0.1 to 100, 0.5 to 100, 0.5 to 50, 1 to 100, 1 to 50, 5 to 75, 5 to 50, or even 10 to 30) micrometer.
11A. The plurality of granules of any preceding A Exemplary Embodiment, wherein the core has a diameter of at least 200 micrometers (in some embodiments, at least 250 micrometers, 300 micrometers, 400 micrometers, 500 micrometers, 750 micrometers, 1 mm, 1.5 mm, or even 2 mm; in some embodiments, in a range from 200 micrometers to 2 mm, 300 micrometers to 1.5 mm, 400 micrometers to 1 mm, 500 micrometers to 1 mm, 300 micrometers to 1 mm, 300 micrometers to 2 mm, or even 1 mm to 2 mm).
12A. The plurality of granules of any preceding A Exemplary Embodiment, wherein the shell has an average thickness of at least 0.1 (in some embodiments, at least 0.5, 1, 2, 5, 10, 25, 50, 75, or even at least 100; in some embodiments, in a range from 0.1 to 100, 0.5 to 100, 0.5 to 50, 1 to 100, 1 to 50, 5 to 75, 5 to 50, or even 10 to 30) micrometer.
13A. The plurality of granules of any preceding A Exemplary Embodiment, wherein each granule collectively comprises at least 80 (in some embodiments, at least 85, 90, or even at least 95; in some embodiments, in a range from 80 to 95) percent by weight collectively of the ceramic particles, alkali silicate, and reaction product of the alkali silicate and the hardener, based on the total weight of the respective granule.
14A. The plurality of granules of any preceding A Exemplary Embodiment, wherein at least one of the first or second ceramic particles independently each have a longest dimension, wherein the granules each have a longest dimension, and wherein the longest dimension of each ceramic particle for a given granule is no greater than 10% (in some embodiments, no greater than 20%) of the longest dimension of said given granule.
15A. The plurality of granules of any preceding A Exemplary Embodiment, wherein the ceramic particles of each granule collectively comprise no greater than 10 (in some embodiments, no greater than 5, 4, 3, 2, 1, or even zero) percent by weight TiO₂, based on the total weight of the granule.
16A. The plurality of granules of any preceding A Exemplary Embodiment, wherein the ceramic particles of each granule collectively comprise no greater than 10 (in some embodiments, no greater than 5, 4, 3, 2, 1, or even zero) percent by weight pure Al₂O₃, based on the total weight of the granule.
17A. The plurality of granules of any preceding A Exemplary Embodiment, wherein the granules have a Tumble Toughness Value of least 70 (in some embodiments, at least 75, 80, 85, 90, 95, 96, 97, 98, or even at least 99) before immersion in water and at least 50 (in some embodiments, at least 55, 60, 65, 70, 75, 80, 85 or even at least 90) after immersion in water at 20° C.±2° C. for two months.
18A. The plurality of granules of any preceding A Exemplary Embodiment, wherein the inorganic binder is collectively present as at least 5 (in some embodiments, at least 10, 15, 20, 25, 30, 35, 40, or 45, or even up to 50; in some embodiments, in a range from 5 to 50, 10 to 50, or even 25 to 50) percent by weight of each granule, based on the total weight of the respective granule.
19A. The plurality of granules of any preceding A Exemplary Embodiment, wherein the granules have sizes in a range from 200 micrometers to 5 millimeters (in some embodiments, in a range from 200 micrometers to 2 millimeters, 300 micrometers to 1 millimeter, 400 micrometers to 1 millimeter; 500 micrometers to 2 millimeters; or even 1 millimeter to 5 millimeters).
20A. The plurality of granules of any preceding A Exemplary Embodiment, wherein the at least one of the first or second ceramic particles independently have an average size in a range from 200 nanometers to 200 micrometers (in some embodiments, in a range from 200 nanometers to 100 micrometers, 250 nanometers to 50 micrometers, 500 nanometers to 20 micrometers, 1 micrometer to 10 micrometers, or even 2 micrometers to 20 micrometers).
21A. The plurality of granules of any preceding A Exemplary Embodiment, wherein at least one of the first or second inorganic binders is amorphous.
22A. The plurality of granules of any of Exemplary Embodiments 1A to 20A, wherein at least one of the first or second inorganic binders is partially crystallized.
23A. The plurality of granules of any preceding A Exemplary Embodiment, wherein at least one of the first or second alkali silicates is at least one of a cesium silicate, lithium silicate, a potassium silicate, or a sodium silicate.
24A. The plurality of granules of any preceding A Exemplary Embodiment, wherein the at least one of the first or second hardeners is amorphous.
25A. The plurality of granules of any preceding A Exemplary Embodiment, wherein the at least one of the first or second hardener is at least one of an aluminum phosphate, an aluminosilicate, a cryolite, a calcium salt (e.g., CaCl₂), or a calcium silicate.
26A. The plurality of granules of any preceding A Exemplary Embodiment, wherein the at least one of the first or second ceramic particles comprise at least one component with Total Solar Reflectance (as determined by the Total Solar Reflectance Test described in the Examples) of at least 0.7. Such exemplary ceramic particles include aluminum hydroxide, metal or metalloid oxide (e.g., silica (e.g., crystoballite, quartz, etc.), an aluminate (e.g., alumina, mullite, etc.), a titanate (e.g., titania), and zirconia), a silicate glass (e.g., soda-lime-silica glass, a borosilicate glass), porcelain, calcite, or marble.
27A. The plurality of granules of any preceding A Exemplary Embodiment, wherein the at least one of the first or second ceramic particles comprise mineral.
28A. The plurality of granules of any preceding A Exemplary Embodiment, wherein the granules further comprise at least one of a functional additive (e.g., rheology modifier (e.g., surfactant), durability modifier (e.g., nanosilica), and fluxing agent), organic binder, or pigment.
29A. The plurality of granules of any preceding A Exemplary Embodiment, wherein each respective granule has a density in a range from 0.5 g/cm³ to 3.0 g/cm³.
30A. The plurality of granules of any preceding A Exemplary Embodiment, wherein the granules are in at least one of the following shapes: cubes, truncated cubes, pyramids, truncated pyramids, triangles, tetrahedras, spheres, hemispheres, or cones.
31A. The plurality of granules of any preceding A Exemplary Embodiment, wherein each granule has a first face and a second face separated by a thickness.
32A. The plurality of granules of Exemplary Embodiment 31A, wherein at least some granules further comprise at least one of a straight or sloping wall.
33A. The plurality of granules of any preceding A Exemplary Embodiment, wherein the granules have a Stain Value not greater than 15 (in some embodiments, not greater than 10, 5, 4, 3, 2, 1, or even not greater than 0.5).
34A. The plurality of granules of any preceding A Exemplary Embodiment, further comprising at least one adhesion promoter.
35A. The plurality of granules of Exemplary Embodiment 34A, wherein the adhesion promotor comprises a polysiloxane.
36A. The plurality of granules of any preceding A Exemplary Embodiment, further comprising at least one dust suppressant.
37A. The plurality of granules of Exemplary Embodiment 36A, wherein the adhesion promotor comprises an acrylic polymer comprising a quaternary ammonium moiety and a nonionic monomer.
38A. The plurality of granules of any preceding A Exemplary Embodiment, wherein the second ceramic particles are present and wherein the first and second ceramic particles are the same.
39A. The plurality of granules of any of Exemplary Embodiments 1A to 37A, wherein the second ceramic particles are present and wherein the first and second ceramic particles are the different.
40A. The plurality of granules of any preceding A Exemplary Embodiment, wherein the first and second inorganic binders are the same.
41A. The plurality of granules of any of Exemplary Embodiments 1A to 39A, the first and second inorganic binders are the different.
1B. A roofing material (e.g., a shingle) comprising the plurality of granules of any preceding A Exemplary Embodiment.
2B. A roofing material of Exemplary Embodiment 1B having a Total Solar Reflectance (TSR) (as determined by the Total Solar Reflectance Test described in the Examples) of at least 60 (in some embodiments, at least 63, 65, or or even at least 70) percent.
1C. A method of making the plurality of granules of any preceding A Exemplary Embodiment, the method comprising:

providing a plurality of ceramic cores comprising the first ceramic particles bound together with the first inorganic binder;

coating each of the ceramic cores with a first layer precursor, wherein the first layer precursor comprises a first aqueous dispersion comprising the second alkali silicate precursor, and the second hardener precursor (optionally further comprising the second ceramic particles); and

curing the coated aqueous dispersion to provide the plurality of granules.

2C. The method of Exemplary Embodiment 1C, wherein the curing is conducted at least in part at a temperature in a range from 40° C. to 500° C., 50° C. to 450° C., 50° C. to 350° C., 50° C. to 250° C., 50° C. to 200° C., 50° C. to 150° C., 50° C. to 100° C., or even 50° C. to 80° C. In some embodiments, curing is conducted in two stages. For example, a first curing stage at least in part at a temperature in a range from 20° C. to 100° C., and a second, final curing stage at least in part at a temperature in a range from 200° C. to 500° C. In some embodiments, the heating rate for each stage is at one or more rates in a range from 5° C./min. to 50° C./min.
3C. The method of either Exemplary Embodiment 1C or 2C, wherein water is present in the first aqueous dispersion up to 75 (in some embodiments, up to 70, 65, 60, 55, 50, 45, 40, 35, 30, 25, 20, or even up to 15; in some embodiments, in a range from 15 to 75, 15 to 50, or even 15 to 35) percent by weight, based on the total weight of the respective aqueous dispersion.
4C. The method of any preceding C Exemplary Embodiment, wherein coating the ceramic core with the shell comprises fluidized bed coating.
5C. The method of Exemplary Embodiment 4C, wherein the fluidized bed coating comprises fluidizing ceramic cores, heating the bed of fluidized cores, and continuously feeding the aqueous dispersion into the fluidized bed.
6C. The method of Exemplary Embodiment 4C, wherein said feeding is over a period of time in a range from 5 minutes to 500 minutes.
7C. The method of Exemplary Embodiments 5C or 6C, wherein said heating is at a temperature in a range from 50° C. to 200° C.

Advantages and embodiments of this invention are further illustrated by the following examples, but the particular material and amounts thereof recited in these examples, as well as other conditions and details, should not be construed to unduly limit this invention. All parts and percentages are by weight unless otherwise indicated.

### Examples

### Illustrative Examples A and B and Prophetic Examples I and II

Illustrative Examples A and B are examples of core granules. Prophetic Examples I and II are examples of the coated core construction. The Illustrative Examples were prepared by mixing the ingredients listed in Table 1 (below) according to the formulas in Table 2 (below), then drying in a pan at 80° C. in an oven, followed by crushing and screening to granule sizes of 425-2000 micrometers.

TABLE 1

| Material | Description | Source |
|---|---|---|
| STAR | Sodium silicate solution in water, | Obtained under trade designation |
| | wt. ratio SiO₂/Na₂O = 2.5:1, 37.1% | “STAR” from PQ Corporation, |
| | solids content | Malvern, PA |
| KSIL1 | Potassium silicate solution in water, | Obtained under trade designation |
| | wt. ratio SiO₂/Na₂O = 2.5:1, 29.1% | “KSIL1” from PQ Corporation |
| | solids content | |
| METAMAX | Reactive metakaolin (anhydrous | Obtained under trade designation |
| | amorphous aluminosilicate) | “METAMAX” from BASF |
| | | Corporation, Florham Park, NJ |
| OPTIPOZZ | Reactive metakaolin (anhydrous | Obtained under trade designation |
| | amorphous aluminosilicate) | “OPTIPOZZ” from Burgess Pigment |
| | | Company, Sandersville, GA |
| OPTIWHITE | Calcined kaolin clay | Obtained under trade designation |
| | | “OPTIWHITE” from Burgess Pigment |
| | | Company |
| CaCO₃ #10 | Calcium carbonate | Obtained under trade designation |
| | | “CaCO₃ #10” from Imerys, Inc., |
| | | Cockeysville, MD |
| RCL9 | Titanium dioxide | Obtained under trade designation |
| | | “RCL9” from Cristal Metals, |
| | | Woodridge, IL |
| MICRAL 632 | Aluminum trihydrate, milled to | Obtained under trade designation |
| | d₅₀ = 3 micrometers | “MICRAL 632” from J. M. Huber |
| | | Corporation, Edison, NJ |

TABLE 2

| | Illustrative EX A | Illustrative EX B | Prophetic EX I | Prophetic EX II |
|---|---|---|---|---|
| Core components, wt. % | | | | |
| STAR | 6.5 | 12.5 | 14.3 | 6.5 |
| METAMAX | 0.0 | 0.0 | 5.3 | 0.0 |
| OPTIWHITE | 19.5 | 16.5 | 9.0 | 19.5 |
| CaCO₃ #10 | 0.0 | 0.0 | 18.0 | 0.0 |
| MICRAL 632 | 19.5 | 16.5 | 0.0 | 19.5 |
| RCL9 | 4.5 | 4.5 | 0.0 | 4.5 |
| Water | 50.0 | 50.0 | 53.4 | 50.0 |
| 1st layer components, wt. % | | | | |
| KSIL1 | No first | No first | 30.1 | 29.1 |
| OPTIWHITE | layer | layer | 12.1 | 11.6 |
| OPTIPOZZ | applied | applied | 4.22 | 4.1 |
| RCL9 | | | 0 | 3.9 |
| Water | | | 53.1 | 51.3 |
| Firing temperature, ° C. | 450 | 450 | 450 | 450 |
| Properties Tested | | | | |
| Pore vol. % | 41 | 29 | | |
| TSR cup | 0.80 | 0.74 | | |

Screened fraction of the granules was placed into a batch oven, where they were heated with heating rate of 2° C./min. up to 450° C., and subsequently cured at that temperature for 3 hours. These samples were tested for porosity of materials and Total Solar Reflectivity (TSR). The results of all tests are summarized in Table 2 (above).

The core granules of Prophetic Example I can be made generally in the same way as described above. The core granules of Illustrative Example A and Prophetic Example I can be coated with a first layer to form Prophetic Example I and II, respectively. The core granules can be suspended in fluidized bed coater (available under the trade designation “GLATT GPCG-1” from Glatt, Weimar, Germany), and equilibrated at a targeted temperature (25-30° C.) prior to application of coating slurry.

The coating slurry can be made as follows: First, structural filler (“MICRAL 632” or “CaCO3#10”), color extender (“OPTIWHITE”) and pigment (“RCL9”), if needed, can be combined. Next, hardener (“METAMAX” or “OPTIPOZZ”) can be combined with liquid silicate (“STAR” or “KSIL1”) and additional water and stirred vigorously for 10 minutes. Then, the dry powdered portion can be combined with the liquid part and mixed via high shear at 500 rpm for at least 15 minutes. Slurry can be maintained in suspension via continuous stirring while being pumped into fluidized bed coater.

For Prophetic Examples I and II, a batch of 1-2 kilograms core granules can be coated with a thin coating (about 10-20 micrometers) which can be applied on top of the core granule to decrease total surface area of the granule by eliminating open porosity and dust. The coating can be applied in fluid bed coater with the following example parameters: product temperature in the range 30-35° C., the atomizing pressure could be around 25 psi (172 kPa), the fluidizing air could be 12-13 fpm (about 3.8 meters per minute), and the spray rate could be 6-7 g/min.

Once the coating process is complete, granules can be taken out of the coater and placed into a batch oven, where they can be heated with heating rate of 2° C./min up to 450° C. and subsequently cured at that temperature for 3 hours.

Foreseeable modifications and alterations of this disclosure will be apparent to those skilled in the art without departing from the scope and spirit of this invention. This invention should not be restricted to the embodiments that are set forth in this application for illustrative purposes.

1. A plurality of granules comprising a ceramic core having an outer surface and a shell on and surrounding the core, wherein the core comprises first ceramic particles bound together with a first inorganic binder, wherein the first inorganic binder comprises reaction product of at least alkali silicate and hardener, wherein the shell comprises at least a first concentric layer, wherein the first layer comprises a second inorganic binder and optionally second ceramic particles, wherein if present the second ceramic particles are bound together with the second inorganic binder, wherein the second inorganic binder comprises reaction product of at least alkali silicate and hardener, wherein for a given granule, the first ceramic particles are present in a first weight percent with respect to the total weight of the core and the second ceramic particles, if present in the first layer of the same granule are in a second weight percent with respect to the total weight of the first layer, wherein for a given granule, the first weight percent is greater than the second weight percent, and wherein the granules have a minimum Total Solar Reflectance of at least 0.7.

2. The plurality of granules of claim 1, wherein for a given granule, the first weight percent of the first ceramic particles is in a range from 40 to 80 weight percent with respect to the core, and wherein for the same granule, the second weight percent of the second ceramic particles is in a range from 0 to 50 weight percent with respect to the first layer.

3. The plurality of granules of claim 1, wherein for a given granule, the core has a first volume percent porosity and the first layer of the same granule has a second volume percent porosity, wherein the first volume percent porosity of the core based on the total volume of the core is greater than the second volume percent porosity of the respective first layer, based on the total volume of the first layer.

4. The plurality of granules of claim 3, wherein for a given granule, the first volume percent porosity is in a range from 25 to 50 volume percent with respect to the core, and wherein for the same granule, the second volume percent porosity is in a range from 0 to 20 volume percent with respect to the first layer.

5. The plurality of granules of claim 1, wherein for a given granule, the core has an average radius and the first layer has a first average thickness, and wherein for the same granule, the average radius of the core is greater than the first average thickness.

6. The plurality of granules of claim 5, wherein the first average thickness is at least 0.5 to 50 micrometers.

7. The plurality of granules of claim 1, wherein the core has a diameter in a range from 200 micrometers to 2 mm.

8. The plurality of granules of claim 1, wherein each of the plurality of granules collectively comprises at least 80 percent by weight collectively of the ceramic particles, alkali silicate, and reaction product of the alkali silicate and the hardener, based on the total weight of the respective granule.

9. The plurality of granules of claim 1, wherein the granules have a Tumble Toughness Value of least 70 before immersion in water and at least 50 after immersion in water at 20° C.±2° C. for two months.

10. The plurality of granules of claim 1, wherein the at least one of the first or second ceramic particles comprise mineral.

11. The plurality of granules of claim 1, wherein the granules have a Stain Value not greater than 15.

12. The plurality of granules of claim 1, the first and second inorganic binders are the different.

13. A roofing material comprising the plurality of granules of claim 1 having a Total Solar Reflectance of at least 60 percent.

14. A method of making the plurality of granules of claim 1, the method comprising:
providing a plurality of ceramic cores comprising the first ceramic particles bound together with the first inorganic binder;
coating each of the ceramic cores with a first layer precursor, wherein the first layer precursor comprises a first aqueous dispersion comprising the second alkali silicate precursor, and the second hardener precursor; and
curing the coated aqueous dispersion to provide the plurality of granules.

15. The method of claim 14, wherein coating the ceramic core with the shell comprises fluidized bed coating, and wherein the fluidized bed coating comprises fluidizing ceramic cores, heating the bed of fluidized cores, and continuously feeding the aqueous dispersion into the fluidized bed.
